(19) United States
(12) Patent Application Publication
(10) Pub. No.: US 2024/0318727 A1
(43) Pub. Date: Sep. 26, 2024

(54) DEVICE AND METHOD FOR ADJUSTING VALVE SEALING ENGAGEMENT

(71) Applicant: DeZURIK, Inc., Sartell, MN (US)

(72) Inventors: John Skalla, Sartell, MN (US); Eb Fuchs, Albany, MN (US); Donald L. Bartell, JR., Beaver Falls, PA (US)

(21) Appl. No.: 18/615,706

(22) Filed: Mar. 25, 2024

Related U.S. Application Data
(60) Provisional application No. 63/454,625, filed on Mar. 24, 2023.

(51) Int. Cl. F16K 1/228

(52) U.S. Cl. CPC F16K 1/228

(57) ABSTRACT

The present application is directed, in part, to a device for delivering epoxy material behind the seat of a butterfly valve, the device comprising: a shaft having a first end, a second end, and an internal lumen between the first and second end. The shaft is configured for insertion into an opening in a valve body such that epoxy injected into the first end of the shaft travels along the internal lumen of the shaft to the seat, thereby applying pressure to the seat to press it toward the valve disc.

This application is a non-provisional application claiming priority to U.S. Provisional Application No. 63/454,625, filed Mar. 24, 2023, and the entire contents are incorporated herein by reference.

### FIELD

Embodiments herein relate to a device, system and methods for adjusting the seat (or seal) on valves, in particular for adjusting the seat or seal on butterfly valves.

### BACKGROUND

Butterfly valves are used in many fluid handling applications, and typically involve a flexible seat that is engaged by a rotating disc to seal the valve. Over time that engagement can deteriorate such that the seat and disc no longer form a fluid-tight seal. A need exists for a means to modify the position of the seat so as to re-form a fluid-tight seal.

### SUMMARY

The present application is directed to a device, system and method for improving the sealing of valves, in particular butterfly valves, especially field-adjustment (after the valves have been installed and used) when leaks are detected. Valves can leak, for example, because of seat wear or damage. For example, when the interference between the seat and disc edge is disturbed, the valve may leak. This can happen even if a gap does not form between the seat and disc edge, although in some cases a gap can also form. Increasing the interference between the seat and disc edge repairs leaks from wear and damage.

The present application is directed, in part, to a device for delivering or injecting epoxy or similar material behind the seat of a butterfly valve. The material is generally a liquid that will harden after injection behind the seat. The device comprises a shaft having a first end, a second end, and an internal lumen between the first and second end; wherein the shaft is configured for insertion into an opening in a valve body. When installed the opening extends from the exterior of the valve body to (or near) the outer diameter of a seat member, where the first end of the device includes threads for securing the device into the opening in the valve body; and wherein the second end of the device terminates in an opening proximal to the seat such that epoxy (or similar material) injected into the first end of the shaft travels along the internal lumen of the shaft to the seat, thereby applying pressure to the seat to press it toward the valve disc.

The components, system and methods of the present disclosure allow for reuse and repeatability, in particular for adjusting the valve seat more than once if appropriate; and in the field if appropriate, to compensate for changes in valve sealing over time.

Each injection device itself is intended for one-time use, but the port in the valve body is machined so that subsequent adjustments can be made with a new injection device after removal of the old injection device. The old device can be removed and discarded and a new device is inserted. The method is repeatable because the valve body is consistently machined to accommodate an insert device. Generally, all devices (per valve size or group of sizes) are manufactured the same, allowing for a new device to be inserted if necessary. In addition, no special tools or devices (such as a drill or drill bit) are generally necessary to perform the methods described herein. A water system that uses valves described herein can have advantages such as more dependability to provide water to the public, more dependability to be available to fight fires, less downtime, less maintenance time, less maintenance cost, less valve replacement cost, etc.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a perspective view of a butterfly valve body in accordance with various embodiments herein.

FIG. 2 is a front view of a butterfly valve body in accordance with various embodiments herein.

FIG. 3 is a cross-sectional view of a butterfly valve body in accordance with various embodiments herein, showing the valve disc, and seal.

FIG. 4 is an enlarged side cross-sectional view of a valve seat, body, disc, and disc edge in accordance with various embodiments herein, showing the disc properly engaging the seat.

FIG. 5 is an enlarged side cross-sectional view of a valve seat, body, disc, and disc edge in accordance with various embodiments herein, showing a small gap between the seat and disc edge.

FIG. 6 is a top view of a butterfly valve body in accordance with various embodiments herein.

FIG. 7 is a is a front view of a butterfly valve body in accordance with various embodiments herein.

FIG. 8 is an enlarged partial view of the seat side of a valve body in accordance with various embodiments herein, showing the seat (but not a delivery device).

FIG. 9 is side elevational view of an epoxy (or similar material) delivery device in accordance with various embodiments herein.

FIG. 10 is a perspective view of an epoxy (or similar material) delivery device in accordance with various embodiments herein.

FIG. 11 is a side cross sectional view of an enlarged partial view of the seat side of a valve body in accordance with various embodiments herein, showing an epoxy (or other material)delivery device inserted into an access port in the valve body.

FIG. 12 is a top view of an epoxy (or other material) delivery device in accordance with various embodiments herein.

FIG. 13 is a side cross-sectional view of an epoxy (or other material) delivery device in accordance with various embodiments herein.

FIG. 14 is a side cross sectional view of an enlarged partial view of the seat side of a valve body in accordance with various embodiments herein, showing an epoxy delivery device inserted into an access port in the valve body.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

The present application is directed, in part, to a device for delivering epoxy or similar material behind the seat of a butterfly valve, the device comprising: a shaft having a first end, a second end, and an internal lumen between the first and second end; wherein the shaft is configured for insertion into an opening in a valve body, the opening extending from the exterior of the valve body to the outer diameter of a seat member. The first end of the device includes threads for securing the device into the opening in the valve body; and the second end of the device terminates at an opening proximal to the seat such that epoxy or similar material injected into the first end of the shaft travels along the internal lumen of the shaft to the seat, where it can apply pressure to the seat to press it toward the valve disc.

The device simplifies and improves external adjustment of seats on butterfly valves that have epoxy-retained resilient seats (or resilient seats retained by a material similar to epoxy). The device allows improving/solving sealing alone, or a combination of increasing pressure and improving/solving sealing.

In certain embodiments, the pre-installed device is ready for use at any time, without further preparation, for seat adjustment using a standard seat adjusting epoxy injection kit. The device can be easily replaced with a new one, using a standard wrench if the seat requires subsequent additional adjustment.

The first end (head) of the device can be threaded and has (for example) a hex head to facilitate easy removal using standard wrenches. Generally, a flat surface is machined on the valve body at the site of the hole to give the hex head a flat surface and also controls the installed depth of the device. The flat surface can precisely controls depth location of insert for repeatability. Typically threaded into the head of the device is a standard size zerk fitting to accommodate a standard seat adjusting epoxy injection kit from the valve manufacturer. If desired, the device can be replaced with another one, simply by unscrewing the existing one and installing another device without special tools.

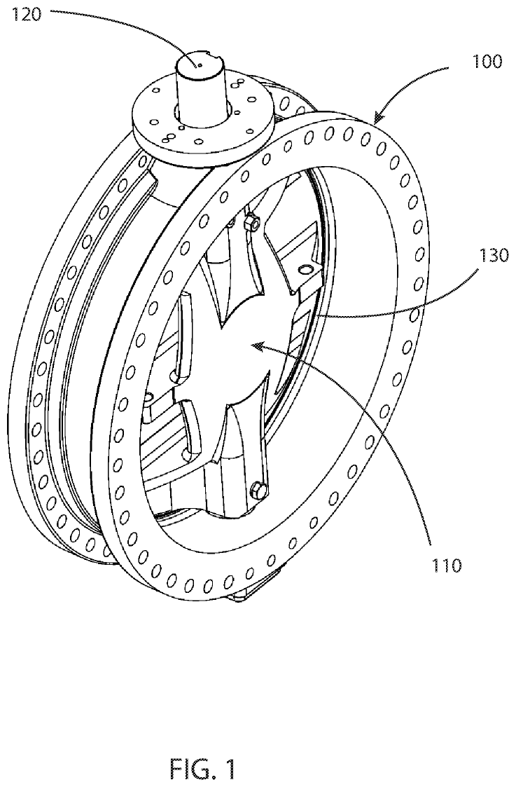

Referring now to the drawings, FIG. 1 is a perspective view of a butterfly valve body 100 in accordance with various embodiments herein. The butterfly valve body 100 includes a disc 110 that rotates within the valve body along shaft 120, and interfaces at a seat 130.

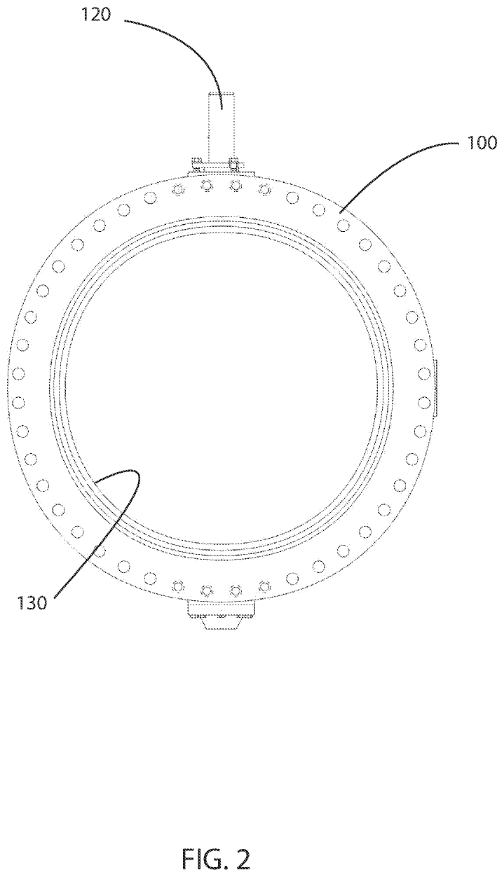

FIG. 2 is a front view of a butterfly valve body 100 in accordance with various embodiments herein, with shaft 120 around which a disc rotates, plus location of seat 130. The valve body 100 may be formed of a range of materials, but is typically metal, and formed of materials such as brass or stainless steel.

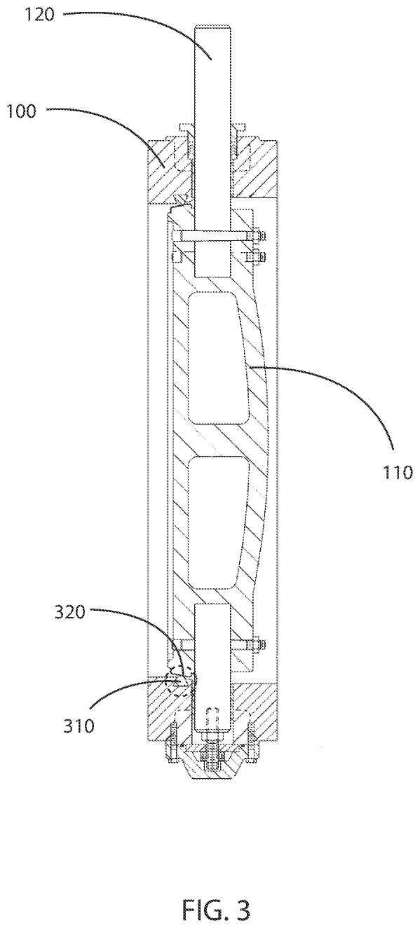

FIG. 3 is a is a cross-sectional view of a butterfly valve body 100 in accordance with various embodiments herein, showing the valve body, disc 110 with disc edge 320, and seat 310.

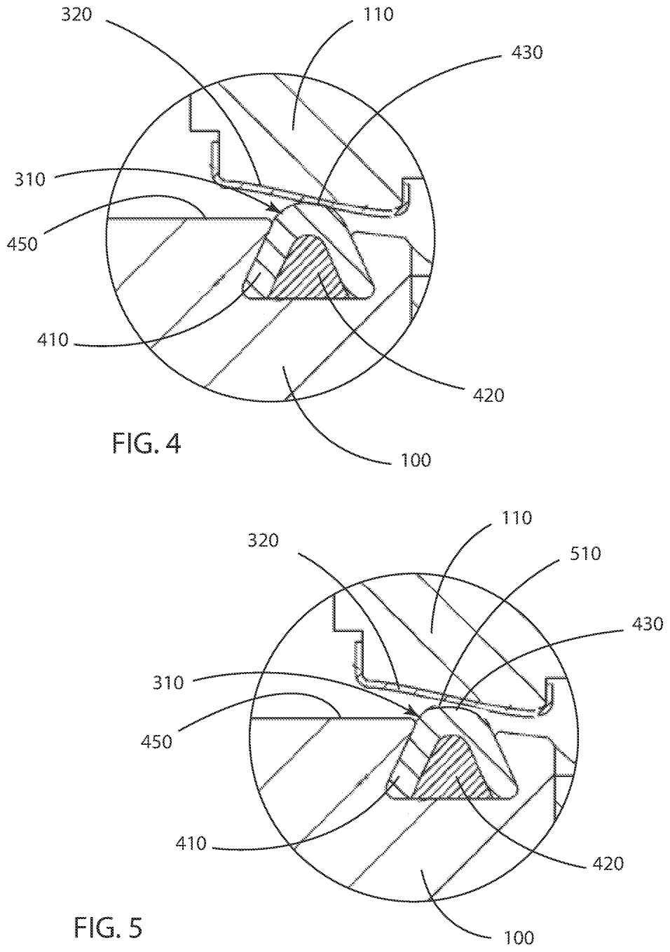

FIG. 4 is an enlarged side cross-sectional view of a seat 310, butterfly valve body 100, disc 110, and disc edge 320 in accordance with various embodiments herein, showing the disc edge 320 properly engaging the seat 310 at top 430 of the seat 310, which makes contact with the disc edge 320. The seat 310 includes a flexible sealing portion 410 along with an epoxy portion 420. The seat 310 protrudes above surface 450 of the interior of the butterfly valve body 100.

FIG. 5 is an enlarged side cross-sectional view of a seat 310, butterfly valve body 100, disc 110, and disc edge 320 in accordance with various embodiments herein, showing a disturbed or irregular seating surface 510 (such as a gap, but there does not need to be gap to require repair). Between the top 430 of seat 310 and disc edge 320.

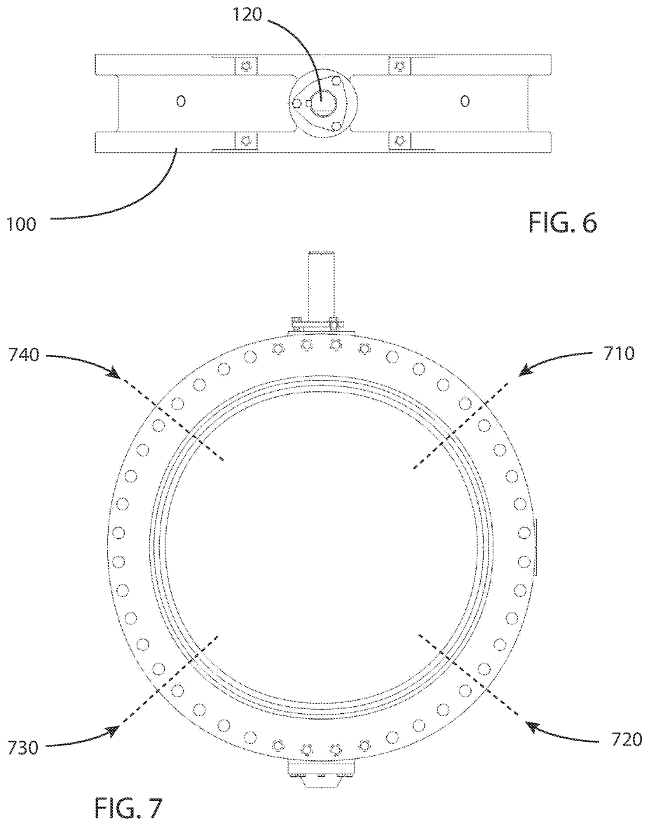

FIG. 6 is a top view of a butterfly valve body 100 in accordance with various embodiments herein, showing the shaft 120 projecting above butterfly valve body 100.

FIG. 7 is a front view of a butterfly valve in accordance with various embodiments herein, including four locations where an epoxy delivery device can be, for example positioned, including location 710, location 720, location 730, and location 740. It should be appreciated that these locations and the number of locations is provided for illustration purposes. The number of locations can be from one to multiple in number, and locations can be positioned as desired.

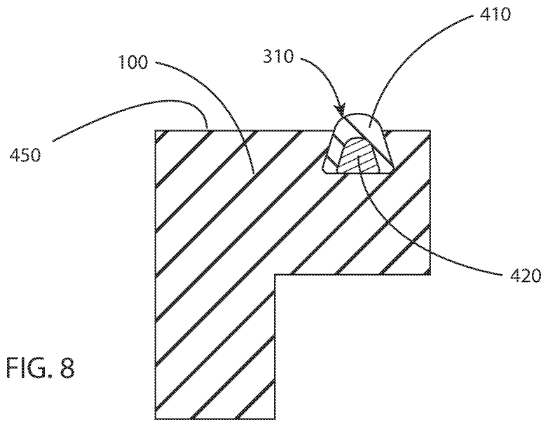

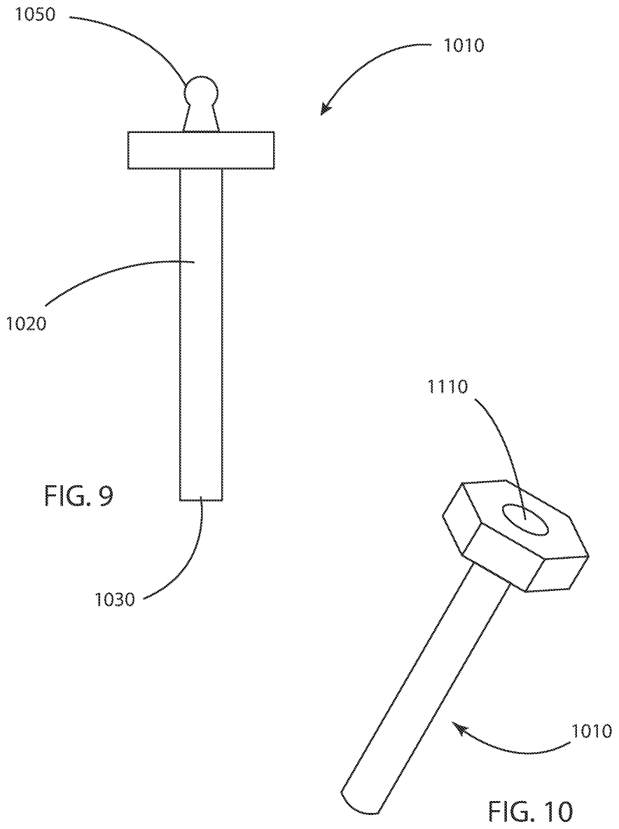

FIG. 8 is an enlarged partial view of the seat side of a butterfly valve body 100 made in accordance with various embodiments herein, showing the seat 310. In this embodiment a standard seat arrangement is shown without any means for external seat adjustment
valve body 100 FIG. 9 is side elevational view of an epoxy delivery device 1010 in accordance with various embodiments herein, including a shaft 1020, tip 1030, and zerk fitting 1050 for adding epoxy.

FIG. 10 is a perspective view of an epoxy delivery device 1010, showing a fill port 1110 leading to an interior lumen, in accordance with various embodiments herein.

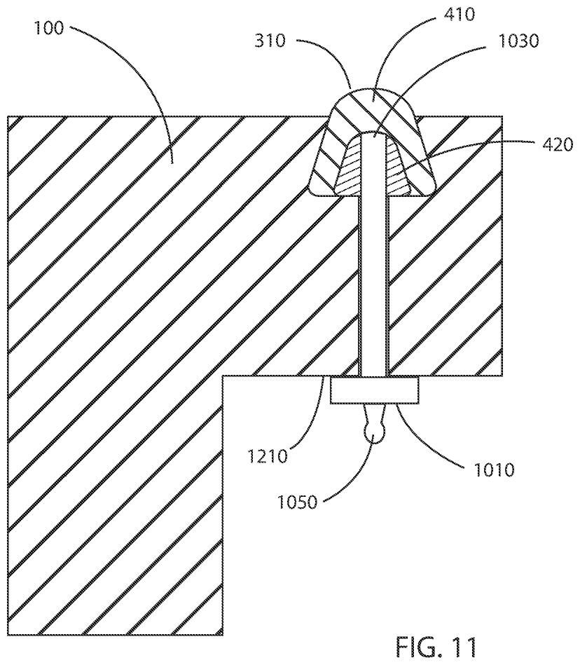

FIG. 11 is a side cross sectional view of an enlarged partial view of the seat side of a butterfly valve body 100 in accordance with various embodiments herein, showing an epoxy delivery device 1010 inserted into an access port in the valve body. Epoxy is added at zerk fitting 1050 flows through the epoxy delivery device 1010 and out the tip 103 to apply a force to the seat 310 and press it into a better seal with disc edge (not shown). A flat portion on the exterior surface 1210 of the butterfly valve body 100 is typically provided to allow for a flush fit. The seat 310 includes a flexible sealing portion 410 along with an epoxy portion 420. The seat 310 protrudes above surface 450 of the interior of the butterfly valve body 100.

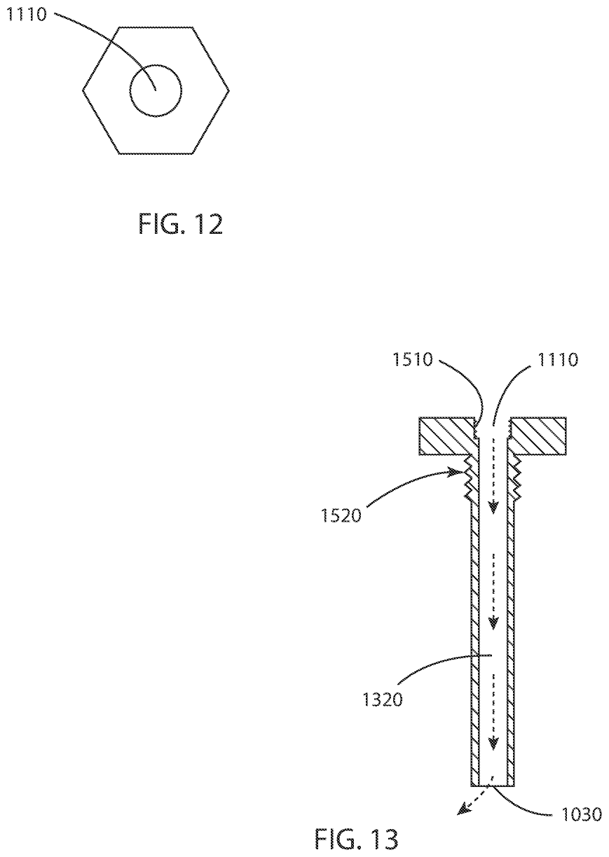

FIG. 12 is a top view of an epoxy delivery device 1010 in accordance with various embodiments herein, including fill port 1110.

FIG. 13 is a side cross-sectional view of an epoxy delivery device in accordance with various embodiments herein, showing an epoxy delivery device with threads 1520 for securing into a valve, along with threads 1510 for securing a zerk fitting (not shown) or plug. Dotted arrows show the path for epoxy to flow through the lumen 1320 and out through the tip 1030.

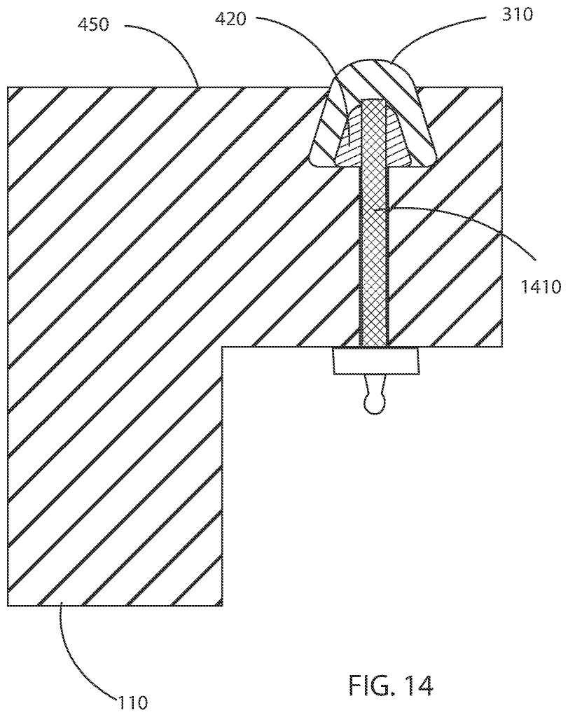

FIG. 14 is a partial side cross sectional view of an enlarged partial view of the seat side of a body in accordance with various embodiments herein showing an epoxy delivery device with epoxy 1410 (or a similar material) filing the device after application of epoxy or other suitable materials to reseat the seat 310. This figure shows the delivery device filled with epoxy that has been pumped into the lumen of the device, with some of the epoxy exiting behind the seat 310 to press the seat into a better fit with the disc (not shown). To repeat this step in the future all that is necessary is to remove the epoxy delivery device and add a new one, followed by injection of additional epoxy (or similar material).

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A device for delivering material behind the seat of a butterfly valve, the device comprising:
a shaft having a first end, a second end, and an internal lumen between the first and second end;
wherein the shaft is configured for insertion into an opening in a valve body, the opening extending from the exterior of the valve body to the outer diameter of a seat member;
wherein the first end of the device includes threads for securing the device into the opening in the valve body;
wherein the second end of the device terminates in an opening proximal to the seat such that material injected into the first end of the shaft travels along the internal lumen of the shaft to the seat, thereby applying pressure to the seat to press it toward the valve disc.

2. The device of claim 1, wherein the material comprises epoxy.

3. The device of claim 1, wherein the first end of the device includes threads for securing to the valve.

4. The device of claim 1, wherein the interior of the lumen includes threads for retaining a sealing plug.

5. The device of claim 1, wherein the first end includes a hex nut.

6. The device of claim 1, wherein the body includes a flat portion for engaging the outer portion of the device.

7. The device of claim 1, wherein the tip extends through the material.

8. The device of claim 1, wherein the tip upon installation approximately meets the boundary between the seat material and existing hardened epoxy.

9. The device of claim 1, wherein the devices are located at one or more locations around the exterior of the valve.

10. The device of claim 1, wherein the devices are located at two or more locations around the exterior of the valve.

11. The device of claim 1, wherein the devices are located at three or more locations around the exterior of the valve.

12. The device of claim 1, wherein the devices are located at four or more locations around the exterior of the valve.

13. The device of claim 1, wherein the device is used for field adjustment for increasing the pressure capability of a butterfly valve.

14. A device inserted behind the seat of a butterfly valve, the device comprising:
a shaft having a first end, a second end, and an internal lumen between the first and second end;
wherein the shaft is inserted into an opening in a valve body, the opening extending from the exterior of the valve body to the outer diameter of a valve seat member;
wherein the second end of the device terminates in an opening proximal to the seat such that material injected into the first end of the shaft travels along the internal lumen of the shaft to the seat, thereby applying pressure to the seat to press it toward the valve disc.

15. A method for repairing valve leakage by adjusting the valve sealing mechanism, the method comprising:
providing a device for delivering epoxy material behind the seat of a butterfly valve, the device comprising:
a) a shaft having a first end, a second end, and an internal lumen between the first and second end;
b) wherein the shaft is configured for insertion into an opening in a valve body, the opening extending from the exterior of the valve body to the outer diameter of a seat member;
c) where the first end of the device includes threads for securing the device into the opening in the valve body;
d) wherein the second end of the device terminates in an opening proximal to the seat such that material injected into the first end of the shaft travels along the internal lumen of the shaft to the seat, thereby applying pressure to the seat to press it toward the valve disc; and
wherein the method is repeatable and reusable with requiring drilling behind the seat of the valve, the device.
